(19) United States
(12) Patent Application Publication
(10) Pub. No.: US 2002/0194246 A1
(43) Pub. Date: Dec. 19, 2002

(54) Context dependent calendar

(75) Inventors: Paul Andrew Moskowitz, Yorktown Heights, NY (US); Clifford A. Pickover, Yorktown Heights, NY (US); William Grey, Millwood, NY (US); Stephen J. Boies, Mahopac, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/882,793

(22) Filed: Jun. 14, 2001

(51) Int. Cl. G06F 9/00

(52) U.S. Cl. 709/102

(57) ABSTRACT

A method, system, and computer program product for modifying event reminders and outputting information associated with event reminders is provided. In one embodiment event reminder information used to remind a user of a scheduled event is extracted from a storage device. The extracted event reminder information is analyzed to identify related output information. The related output information is then sent to an output device to be presented to a user, thereby enabling the display of information correlated to events of importance to the user. In another embodiment event reminder information used to remind a user of a scheduled event is extracted from a storage device. Information related to the scheduled event is then extracted from a storage device. The extracted event reminder information is analyzed to identify modifications to apply to said event reminder information, thereby enabling event reminders to be updated to reflect correlated events of importance to the user.

### BACKGROUND OF THE INVENTION

1. Technical Field

The present invention relates generally to the field of computer software and, more particularly, to computer calendars.

2. Description of Related Art

Computers and the Internet have become cultural fixtures as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Operating costs may be reduced by providing informational guides and/or searchable databases of public records online.

One of the features provided by computers and/or through the Internet are calendars and other personal organizational lists. These calendars, as well as other products, provide users with means for organizing the various aspects of their lives. For example, items can be entered into these products such that visual, auditory, or other reminders are presented to the user at appropriate times. These products also allow users to avoid scheduling conflicts as well as many other numerous conveniences. However, the only user specific information that current electronic calendars provide users is information supplied by the user. It would be desirable, however, to add value to these products by providing calendars that supply information that may be of value to specific individuals that is in addition to information supplied by the user.

### SUMMARY OF THE INVENTION

The present invention provides a method, system, and computer program product for modifying event reminders and outputting information associated with event reminders. In one embodiment event reminder information used to remind a user of a scheduled event is extracted from a storage device. The extracted event reminder information is analyzed to identify related output information. The related output information is then sent to an output device to be presented to a user, thereby enabling the display of information correlated to events of importance to the user. In another embodiment event reminder information used to remind a user of a scheduled event is extracted from a storage device. Information related to the scheduled event is then extracted from a storage device. The extracted event reminder information is analyzed to identify modifications to apply to said event reminder information, thereby enabling event reminders to be updated to reflect correlated events of importance to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a block diagram of a calendar system for providing a context dependent calendar in accordance with the present invention;

FIG. 5 depicts a pictorial diagram of a calendar display in accordance with the present invention; and

FIG. 6 depicts a process flow and program function for providing information to a user based on the content of an electronic calendar in accordance with the present invention.

### DETAILED DESCRIPTION OF THE PREFERRED EMBODIMENT

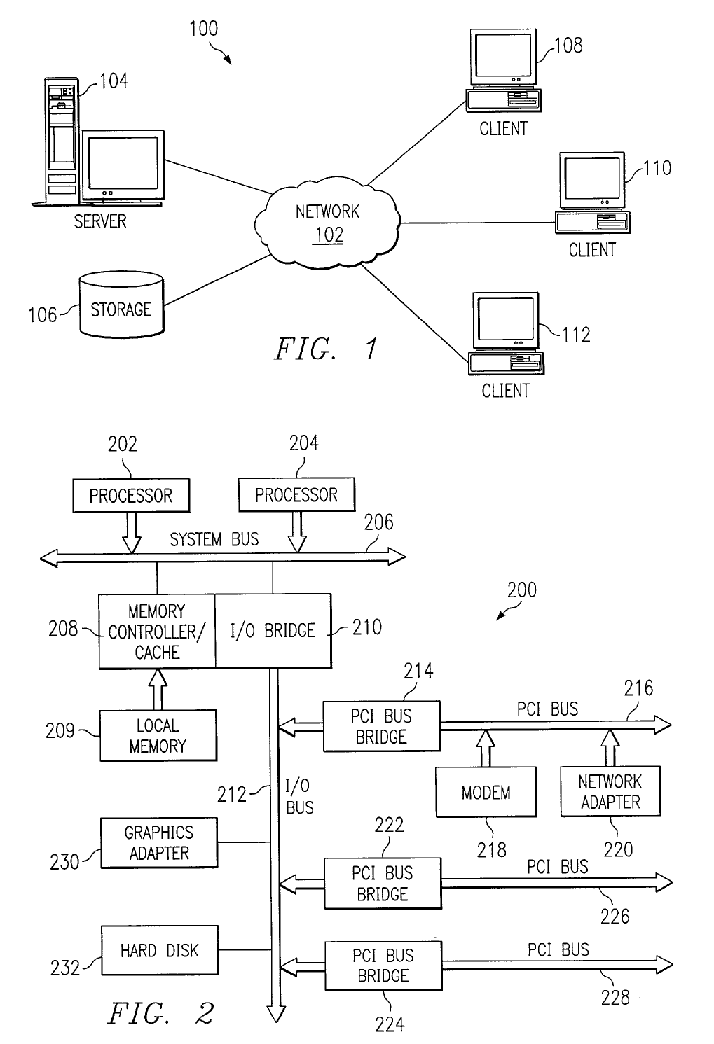

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

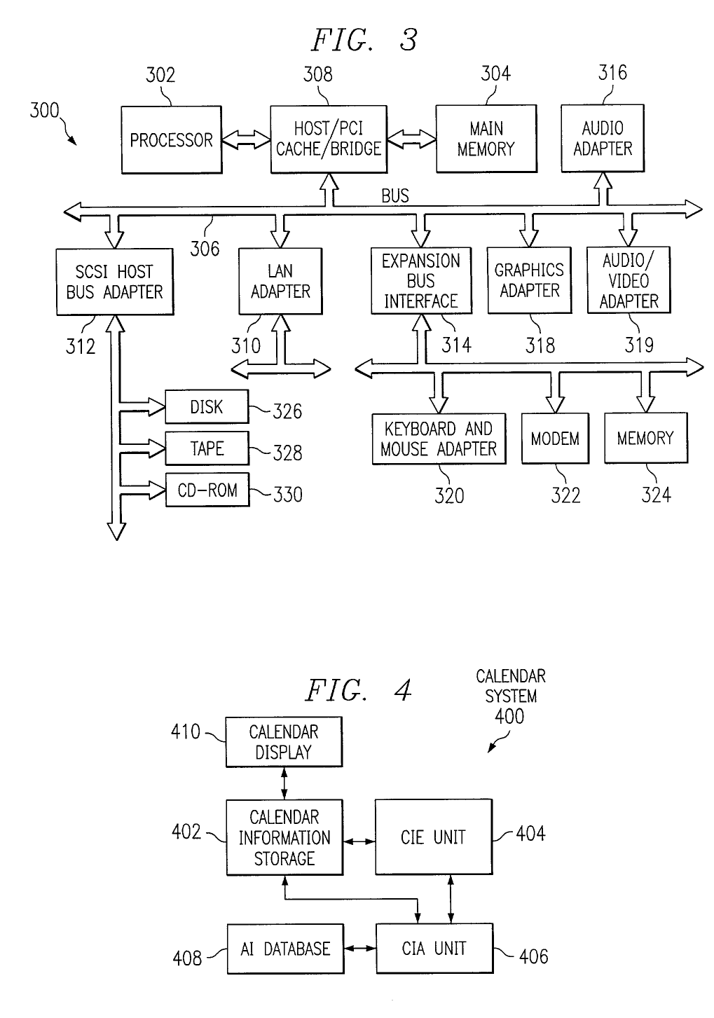

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

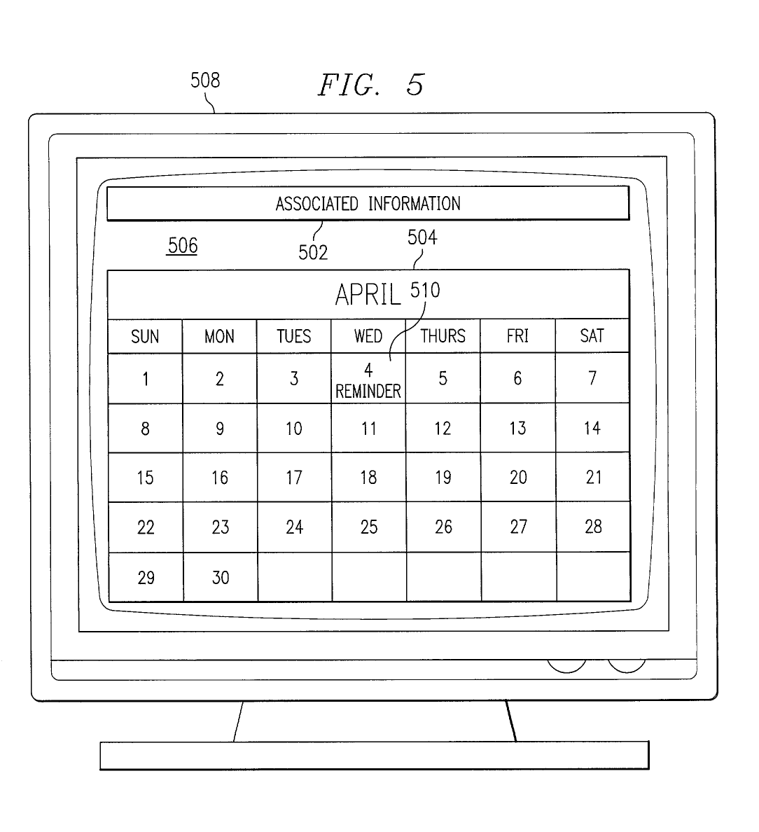

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

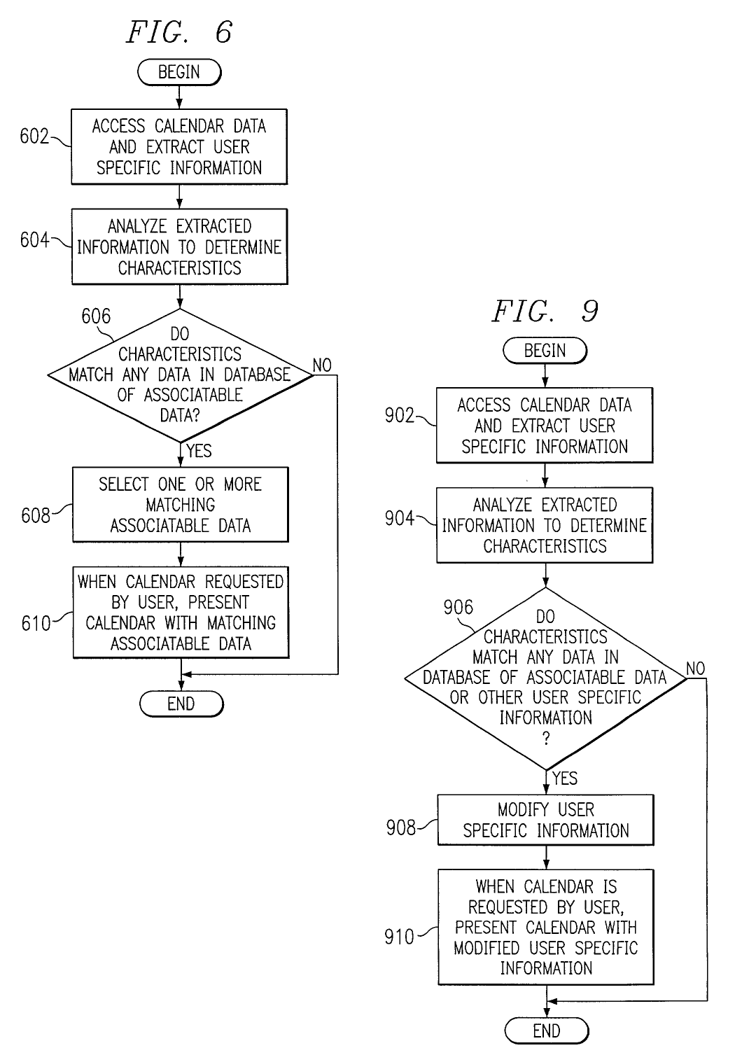

With reference now to FIG. 4, a block diagram of a calendar system for providing a context dependent calendar is depicted in accordance with the present invention. Calendar system 400 may be implemented in distributed data processing system 100 in FIG. 1 either entirely on an individual system, such as, for example, client 108, or distributed among two or more systems. Calendar system 400 includes a calendar display 410 for displaying an electronic calendar to a user, a calendar information (CI) storage unit 402, a calendar information extracting (CIE) unit 404, a calendar information analyzing (CIA) unit 406, and an associatable information (AI) database 408.

CI storage unit 402 stores information entered by a user related information such as, for example, scheduling, appointments, reminders, etc. This information may be calendar entries that can be based upon established templates, such as, for example, a wedding calendar template, or upon templates that can be created by a user or abstracted out of existing calendar entries. This information may be associated with calendar dates. CIE unit 404 searches the information stored in CI storage unit 402 including template entries and retrieves user entries and correlated dates as well as other information, such as holidays or days of personal importance such as birthdays. The extracted information is forwarded by CIE unit 404 to CIA unit 406. CIA unit 406 analyzes the extracted information to determine whether any of the information correlates with any key words in AI database 408. If a keyword is matched, then information associated with the keyword in the AI database 408 is extracted by CIA unit 406 and sent to CI storage unit 402 such that when the user displays the calendar on calendar display 410, the information associated with the keyword from the AI database 408 is displayed as well.

For example, if a calendar entry for a specific date contains a user entry reminding the user to pickup orange juice on the way home from work, the CIA unit 406 may discover entry containing orange juice and retrieve an advertisement for a specific brand of orange juice from AI database 408. This associated information along with instructions concerning the time, placement, and manner of presenting the associated information to the user may then be sent back to CI storage unit 402 and stored until the calendar is displayed on calendar display 410. When the calendar is displayed to the user on calendar display 410, the associated information, which in the orange juice example is an advertisement for the specific brand of orange juice, is displayed as well via calendar display 410. If the calendar is provided to the user by a third party, entities supplying the associated information may be required to pay a fee to have their information, such as advertisements, provided to the user.

The CIA 406 may also be configured to have certain advertisements displayed depending on the time of day, day of the week, or date that the user views the calendar. For example, if the user views the calendar at 3:00 am, the display may include an advertisement for a sleeping pill. If, however, the time of day is 8:00 am, the display may include an advertisement for a specific brand of coffee. If a holiday or birthday or other special day is approaching, the CIA 406 may have advertisements related to the special day displayed along with the calendar.

Information in the AI database 408 may include, in addition to advertisements, coupons, discount authorizations, maps, traffic and weather information. If AI database 408 contains dynamic information such as traffic reports or weather reports, this information may be updated periodically such that the information in AI database 408 is fresh. The CIA unit 406 may also make recommendations to the user based upon the associated information and these recommendations presented to the user. For example, if the user has an entry reminding the user to drive to a certain location, the CIA unit 406 may suggest a route to take to arrive at the destination and, perhaps, present a map illustrating the suggested route.

The information in AI database 408 that CIA unit 406 chooses to display may also be a photograph, picture or other graphic of a person or object associated with the day of the week, date, or time. This may be particularly useful for remembering birthdays, anniversaries, etc. For example, a photo of the user's spouse may appear on or before an anniversary or birthday, or alternatively, layered over the date on the calendar of the special day for which a reminder is needed. In such case, AI database 408 may be located on the user's data processing system rather than on a remote system that may be accessible to others, thus insuring some level of privacy for the user's private information.

If the components are contained on more than one data processing system, communications between components can be through a wired or wireless network, such as, for example, distributed data processing system 100 in FIG. 1.

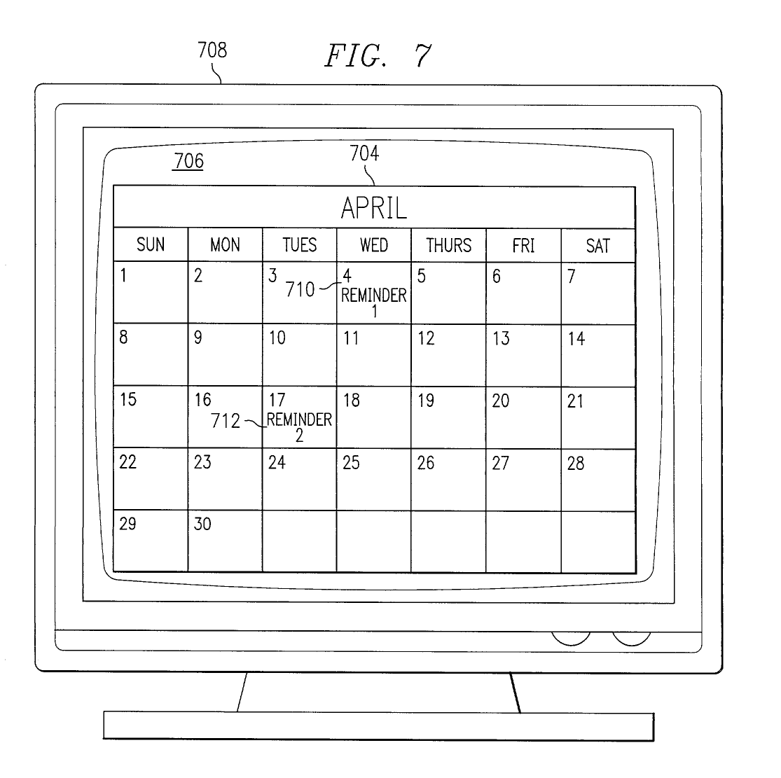

With reference now to FIG. 5, a pictorial diagram of a calendar display is depicted in accordance with the present invention. Video display terminal (VDT) 508 contains a display 506 presenting a calendar 504 along with associated information 502. The calendar entry for Apr. 4 contains a reminder 510. Continuing with the orange juice example, the reminder 510 may read “pickup orange juice on the way home from work.” Thus, on Apr. 4, the calendar 504 may be displayed along with an advertisement for a specific brand of orange juice as the associated information 502. Thus, by analyzing the calendar entries and other user information, the present invention provides advertisements or other information to the user based on the content of the user information.

In other embodiments, rather than presenting the associated data proximate to the calendar as illustrated in FIG. 5, the associated data is presented to the user before the calendar is presented to the user, thus requiring the user to acknowledge the associated data prior to accessing the electronic calendar.

In yet another embodiment, the associated data is presented over various dates on the calendar. Thus, for example, the box representing Apr. 4 may have an advertisement for a specific brand of milk while the box representing Apr. 11 may have a photograph of the user's spouse indicating that Apr. 11 is the spouse's birthday. Thus, in some embodiments, more than one associated data entry may be presented to the user.

Also, in other embodiments, the associated data presented to the user with the calendar may change with time. Thus, a user may view the electronic calendar and have the information presented over, for example, the box representing Apr. 4 change from, for example, an advertisement for milk to an advertisement for toothpaste.

In some embodiments, the associated data is selectable by the user, such as by clicking a button on a mouse when the pointer is over the associated information 502. Thus, for example, if the associated information is an advertisement, selecting the advertisement may take the user to that businesses web page on a browser or otherwise allow the user to purchase the advertised product. Selecting the associated information 502 may also bring up more information about the associated information. Thus, if the associated information is an advertisement for a product, additional information about the product may be presented to the user. The associated information 502 may also be presented with other data allowing the user to indicate that the user wishes not to be presented with, for example, a specific advertisement or type of information again.

The associated information may also be dynamic information that changes with time. In such case, for example, the associated information may only be presented dependent upon the occurrence of a specific event (i.e., a notice that IBM stock exceeds $125/share once the threshold has been satisfied).

VDT 508, calendar 504, and associated information 502 are merely examples of one embodiment for presenting a calendar and other useful information to a user based on the content of user calendar entries. The calendar may be displayed on any of a variety of displays and data processing systems including, for example, the calendar may be displayed on a personal digital assistant (PDA), a cell phone, a television, or printed out via a printer. Other types of electronic devices may be used as well. Also, in other embodiments, the calendar may be presented to the user using audio, visual, multimedia, tactile, and/or olfactory devices.

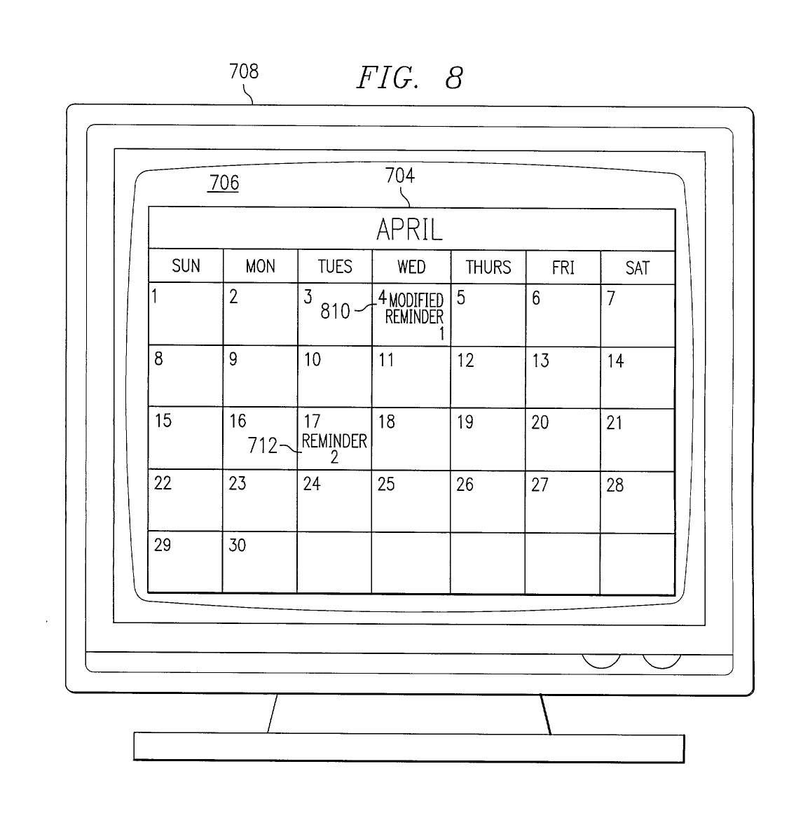

With reference now to FIG. 6, a process flow and program function for providing information to a user based on the content of an electronic calendar is depicted in accordance with the present invention. To being, the electronic calendar data is accessed and user specific and other context information is extracted from the data (step 602). The contents of the extracted information is analyzed to determine characteristics (step 604) and a determination is made as to whether any of these characteristics match any data in a database of associatable information, by for example, determining whether the extracted information matches any keywords associated with associatable information (step 606). For example, an advertisement for a specific brand of orange juice may have keywords that include, for example, juice, orange juice, drink, and breakfast. If any of the extracted information includes one of these words, then an advertisement for that brand of orange juice may be selected. If none of the extracted information is correlated with associatable information, then the process ends. However, if one or more characteristics of the extracted data match any of the associatable information, then one or more of the associatable information are selected (step 608) and presented, with the calendar, to the user (or other user(s)) when the calendar is requested by the user. Thus, advertisers may target advertisements to specific users who have scheduled events that indicate that they may be more receptive to the advertisement than the average consumer.

With reference now to FIGS. 7 and 8, pictorial diagrams of a calendar depicting an alternative embodiment of the present invention in which event reminder information is modified based on other occurrences. Video display terminal (VDT) 708 contains a display 706 presenting a calendar 704. Calendar 704 contains two reminders, reminder 1 710 and reminder 2 712 for reminding a user of important events. A calendar system, such as, for example, calendar system 400 in FIG. 4, may analyze the user's reminders 710 and 712 and extract characteristics that may be used in connection with other events, data, or other event reminders to modify the reminders 710 and 712. Thus, in the example depicted in FIG. 8, the calendar system has analyzed the user event reminder information 710 and 712 and determined that reminder 1 710 should be modified. Thus, in FIG. 8, reminder 1 710 has been replaced with modified reminder 1 810. The modified reminder 1 810 may relate to, for example, weather information, traffic information, airline departure information, train departure information, bus departure information, meeting conflicts, meeting overruns, personal emergencies, public emergencies, sales and promotions, and acts of nature. The modified reminder 1 810 may relate to, for example, rescheduling an event, rescheduling a reminder notification, changing an event location, changing event participants, changing the event medium (i.e. from face to face to phone), changing event contact information, canceling an event, substituting an alternate event (i.e. if two meetings scheduled simultaneously, override the original high priority meeting), and automatically scheduling a new event (i.e. if the user's 5:00 p.m. meeting is canceled, block off the time and buy theater tickets; or if there is a special promotion on theater tickets for a play the user wants to see, cancel the last meeting of the day, and book theater tickets instead).

To aid in understanding this embodiment, consider the following example. Suppose that the user had a meeting scheduled for 3:00 p.m. to 6:00 p.m. on Apr. 4 with a reminder represented by reminder 1 710. However, further suppose that the user had indicated that because of an airline reservation on a flight scheduled to depart at 6:00 p.m., which was also scheduled in the calendar 704 (but not shown in the depicted example), that the user must leave the meeting at 4:00 p.m. in order to make the flight. Further suppose that the calendar system is connected to the airline scheduling system and monitors the status of the scheduled flight. This could be accomplished directly by the calendar system through, for example, the connecting to the Internet and accessing a web page or database of flight information, or indirectly by the calendar system through receipt of e-mail alerts from the airline scheduling system. If the flight on which the user is scheduled is listed as delayed until 8:00 p.m., the calendar system automatically updates the calendar 704 with modified reminder 1 810 that indicates that the user may now stay until the completion of the meeting rather than leaving early, since the user will still have time after the scheduled completion of the meeting to arrive at the airport to make the flight.

As another example, consider that situation in which a user has a meeting scheduled for 3:00 p.m. to 6:00 p.m. on Apr. 4 indicated by reminder 1 710. Suppose that another the user is made aware of another event, such as, for example, a sporting event, that the user would like to attend, but that conflicts with the scheduled meeting. The user could enter an alternative schedule that the user finds desirable and, if the calendar system receives an indication, for example, via e-mail, that the person with which the user has the scheduled meeting has canceled the meeting, the user's calendar is automatically updated to show the sporting event as the new modified reminder 1 810.

With reference now to FIG. 9, a process flow and program function for automatically updating event reminder information in a user calendar is depicted in accordance with the present invention. To begin, the calendar system accesses the calendar data and extracts user specific information, such as, for example, event reminder information (step 902). The calendar system then analyzes extracted information to determine characteristics of the user specific information, such as, for example, the time of a scheduled event or the type of event (step 904). The system then determines whether the characteristics match any data in a database of associatable data or other user specific information (step 906). If characteristics of the extracted data are correlated with other data, then the calendar system modified the user specific information (step 908). For example, the calendar system may notice that some scheduled events overlap with other scheduled events. If the system determines that one of the events has been canceled or delayed, for example, via an e-mail alert, the calendar system updates or modifies the scheduled entries to reflect the changes. The calendar system then presents the calendar with modified user specific information when the calendar is requested by the user (step 910). If, in step 906, the calendar system determines that there are no updates, then the process ends.

Although the present invention has been described primarily with reference to a traditional electronic calendar, the present invention may be implemented with other electronic personal organizational listings or arrays, such as, for example, an electronic diary, television guide listing, a scheduler, a to-do list, a day planner, a reminder listing, a radio broadcast listing, a movie listing, an entertainment listing, a list of menu items, and specialized calendars, such as pregnancy, diet, motivational, and celebrity calendars.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for outputting information associated with event reminders, the method comprising:
extracting event reminder information from a storage device, the event reminder information being used to remind a user of a scheduled event;
analyzing the extracted event reminder information to identify related output information; and
sending the related output information to an output device.

2. The method as recited in claim 1, further comprising:
presenting the related information to a user.

3. The method as recited in claim 2, wherein presenting the related information to the user comprises displaying the related output information.

4. The method as recited in claim 3, wherein the event reminder information is correlated to a calendar and the related output information is displayed to the user proximate to a display of the calendar.

5. The method as recited in claim 3, wherein the event reminder information is correlated to a calendar and the related output information is displayed prior to displaying the calendar.

6. The method as recited in claim 3, wherein the event reminder information is correlated to a calendar and the related output information is displayed such that it occludes at least a portion of at least one date area on the calendar, wherein the date corresponds to the event reminder information.

7. The method as recited in claim 1, wherein the related output information includes at least one of an advertisement, a map, a weather report, traffic information, coupons, and discount authorizations.

8. The method as recited in claim 2, wherein presenting the related output information comprises using at least one of audio, visual, multimedia, tactile, and olfactory modes.

9. The method as recited in claim 2, further comprising:
sending additional information to the presentation device if the related information is selected.

10. The method as recited in claim 2, further comprising:
responsive to selection of the related output information, purchasing an associated product.

11. The method as recited in claim 2, wherein the related information presented is determined at least in part based upon the time the event reminder information is requested by a user.

12. The method as recited in claim 2, wherein the related output information is determined at least in part based upon the occurrence of a specific event.

13. The method as recited in claim 1, wherein the event reminder information is associated with one of a calendar, a television guide listing, a schedule, a to-do list, a day planner, a reminder listing, a radio broadcast listing, a movie listing, an entertainment listing, and a list of menu items.

14. A computer program product in a computer readable media for use in a data processing system for outputting information associated with event reminders, the computer program product comprising:
first instructions for extracting event reminder information from a storage device, the event reminder information being used to remind a user of a scheduled event;
second instructions for analyzing the extracted event reminder information to identify related output information; and
third instructions for sending the related output information to an output device.

15. The computer program product as recited in claim 14, further comprising:
fourth instructions for presenting the related output information to a user.

16. The computer program product as recited in claim 15, wherein presenting the related output information to the user comprises displaying the related output information.

17. The computer program product as recited in claim 16, wherein the event reminder information is correlated to a calendar and the related output information is displayed to the user proximate to a display of the calendar.

18. The method as recited in claim 16, wherein the event reminder information is correlated to a calendar and the calendar is displayed in response to a user selecting the related output information displayed prior to displaying the calendar.

19. The computer program product as recited in claim 16, wherein the event reminder information is correlated to a calendar and the related output information is displayed such that it occludes at least a portion of at least one date area on the calendar, wherein the date corresponds to the event reminder information.

20. The computer program product as recited in claim 15, further comprising:
fifth instructions for sending additional information to the presentation device if the related information is selected.

21. The computer program product as recited in claim 15, further comprising:
fifth instructions, responsive to selection of the related output information, for purchasing an associated product.

22. A system for outputting information associated with event reminders, the system comprising:
an extraction unit which extracts event reminder information from a storage device, the event reminder information being used to remind a user of a scheduled event;
an analyzer which analyzes the extracted event reminder information to identify related output information; and
a transmitter which sends the related output information to an output device.

23. The system as recited in claim 22, further comprising:
a presentation unit which presents the related information to a user.

24. The system as recited in claim 23, wherein the presentation unit includes a display.

25. The system as recited in claim 23, wherein the presentation unit is a personal digital assistant.

26. The system as recited in claim 23, wherein the presentation unit is a data processing system.

26. The system as recited in claim 23, wherein the presentation unit is a telephone.

27. The system as recited in claim 22, wherein the extraction unit, the analyzer, and the transmitter are implemented on one or more servers in a network and the transmitter sends the related output information to the presentation device via a network connection.

28. The system as recited in claim 22, wherein the related output information is stored on a user's data processing system.

29. The system as recited in claim 22, wherein the event reminder information are calendar entries and further comprising:
a calendar template for entering calendar entries.

30. A method for modifying event reminders, the method comprising:
extracting event reminder information from a storage device, the event reminder information being used to remind a user of a scheduled event;
extracting related information from a storage device;
analyzing the extracted event reminder information and related information to identify modifications to apply to said event reminder information.

31. The method as recited in claim 30, wherein said related information comprises at least one of weather information, traffic information, airline departure information, train departure information, bus departure information, meeting conflicts, meeting overruns, personal emergencies, public emergencies, sales and promotions, and acts of nature.

32. The method as recited in claim 30, wherein said modifications comprise at least one of rescheduling an event, rescheduling a reminder notification, changing an event location, changing event participants, changing the event medium, changing event contact information, canceling an event, substituting an alternate event, and automatically scheduling a new event.

33. The method as recited in claim 30, further comprising:
presenting the event reminder information with modifications to a user.

34. The method as recited in claim 33, wherein presenting the event reminder information with modifications to the user comprises displaying the event reminder information with modifications.

35. A computer program product in a computer readable media for use in a data processing system for modifying event reminders, the computer program product comprising:
first instructions for extracting event reminder information from a storage device, the event reminder information being used to remind a user of a scheduled event;
second instructions for extracting related information from a storage device;
third instructions for analyzing the extracted event reminder information and related information to identify modifications to apply to said event reminder information.

36. A system for modifying event reminders, the system comprising:
an extraction unit which extracts event reminder information from a storage device, the event reminder information being used to remind a user of a scheduled event;
a related information extraction unit which extracts related information from a storage device;
a modification unit which analyzes the extracted event reminder information and related information to identify modifications to apply to said event reminder information.

37. A method for outputting advertisement information associated with event reminders, the method comprising:
extracting event reminder information from a storage device, the event reminder information being used to remind a user of a scheduled event;
analyzing the extracted event reminder information to identify related advertisement output information; and
sending the related advertisement output information to an output device.

38. A computer program product in a computer readable media for use in a data processing system for outputting advertisement information associated with event reminders, the computer program product comprising:
first instructions for extracting event reminder information from a storage device, the event reminder information being used to remind a user of a scheduled event;
second instructions for analyzing the extracted event reminder information to identify related advertisement output information; and
third instructions for sending the related advertisement output information to an output device.

39. A system for outputting advertisement information associated with event reminders, the system comprising:
an extraction unit which extracts event reminder information from a storage device, the event reminder information being used to remind a user of a scheduled event;
an analyzer which analyzes the extracted event reminder information to identify related advertisement output information; and
a transmitter which sends the related advertisement output information to an output device.
